(19) United States
(12) Patent Application Publication
(10) Pub. No.: US 2026/0233787 A1
(43) Pub. Date: Aug. 13, 2026

(54) VEHICLE BODY STRUCTURE

(71) Applicant: SUBARU CORPORATION, Tokyo (JP)

(72) Inventor: Hiroyasu ITO, Tokyo (JP)

(21) Appl. No.: 19/449,978

(22) Filed: Jan. 15, 2026

(30) Foreign Application Priority Data
Feb. 12, 2025 (JP) 2025-020439

(51) Int. Cl. B62D 29/04; B62D 27/02

(52) U.S. Cl. CPC B62D 29/043; B62D 27/02

(57) ABSTRACT

A vehicle body structure having a flat plate shape. The vehicle body structure includes a plurality of fiber-reinforced resin composites having a tubular shape or a hat shape and coupled together. The fiber-reinforced resin composites include a plurality of first parts, a plurality of second parts, and a plurality of intersections. The first parts extend in a front-rear direction or a left-right direction of a vehicle body, and the second parts extend in oblique directions that all slant to the front-rear direction and the left-right direction of the vehicle body. Some of the second parts are disposed on diagonal lines of the vehicle body structure. At the intersections, the first parts and the second parts are coupled together while intersecting with each other in the same plane.

### CROSS-REFERENCE TO RELATED APPLICATIONS

The present application claims priority from Japanese Patent Application No. 2025-020439 filed on February 12, 2025, the entire contents of which are hereby incorporated by reference.

### BACKGROUND

The technique of the disclosure relates to a vehicle body structure having a flat plate shape and using a fiber-reinforced resin composite.

Components in a vehicle body structure of an automobile, for dealing with a lateral collision of a vehicle body, include a cross member extending in a left-right direction of the vehicle body and a brace for reinforcing an engine area or a suspension area. Components for dealing with a frontal collision of the vehicle body include a front side frame extending in a front-rear direction of the vehicle body and a load path (load transmission path) under a floor. Since torsional vibration occurs in the vehicle body, structural members may be provided in oblique directions that all slant to the front-rear direction and the left-right direction of the vehicle body.

For example, Japanese Unexamined Patent Application Publication (JP-A) No. 2022-112090 discloses a vehicle lower part structure including a pair of side sills extending in the front-rear direction of a vehicle along an edge of a floor panel, a pair of rear side members extending from a rear end of the vehicle to the front of the vehicle and coupled to rear ends of the pair of side sills, a pair of suspension mounts coupled to the pair of rear side members and to which swingable rear-wheel suspensions are fixed, and a joint member including an X joint part including portions extending obliquely rearward from the pair of side sills, intersecting with each other, and further respectively coupled to the pair of rear side members. The X joint part of the joint member and the pair of suspension mounts are adjacent to each other on the pair of rear side members or face each other while separated from each other by each of the pair of rear side members.

### SUMMARY

An aspect of the technique of the disclosure provides a vehicle body structure having a flat plate shape. The vehicle body structure includes a plurality of fiber-reinforced resin composites each having a tubular shape or a hat shape and coupled together. The fiber-reinforced resin composites include a plurality of first parts, a plurality of second parts, and a plurality of intersections. The first parts extend in a front-rear direction or a left-right direction of a vehicle body, and the second parts extend in oblique directions that all slant to the front-rear direction and the left-right direction of the vehicle body. Some of the second parts are disposed on diagonal lines of the vehicle body structure. At the intersections, the first parts and the second parts are coupled together while intersecting with each other in the same plane.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a schematic plan view of a portion of a vehicle body structure according to an embodiment of the disclosure;

FIG. 2 is a side view of the vehicle body structure according to the embodiment;

FIG. 3 is a perspective view of a configuration example of an intersection of the vehicle body structure according to the embodiment;

FIG. 4 is an exploded perspective view of the configuration example of the intersection of the vehicle body structure according to the embodiment;

FIG. 5 is a sectional view of the configuration example of the intersection of the vehicle body structure according to the embodiment;

FIG. 6 is an exploded perspective view of a configuration example of an intersection of a vehicle body structure according to a modification of the embodiment;

FIG. 7 is a sectional view of the configuration example of the intersection of the vehicle body structure according to the modification of the embodiment;

FIG. 8 is a perspective view of a configuration example of an intersection of a vehicle body structure according to an embodiment;

FIG. 9 is a sectional view of the configuration example of the intersection of the vehicle body structure according to the embodiment; and

FIG. 10 illustrates an example of a manufacturing method of the vehicle body structure according to the embodiment.

### DETAILED DESCRIPTION

The vehicle lower part structure disclosed in JP-A No. 2022-112090 is configured by joining structural members that are manufactured by press-forming steel plates, and the structural members are vertically layered. Thus, there may be a limit to how thin the vehicle lower part structure can be.

It is desirable to provide a vehicle body structure allowing reduction in the thickness of the vehicle body structure having a flat plate shape and allowing distribution of the input load in multi-axial directions.

Hereinafter, embodiments of the disclosure will be described in detail with reference to the accompanying drawings. The specific dimensions, materials, numerical values, and the like given in the following embodiments are merely examples for facilitating the understanding of the disclosure and are not intended to limit the disclosure unless otherwise specified. Note that, in the present specification and the drawings, the description of constituent elements having substantially the same function configurations is omitted without repetition by denoting the constituent elements by the same reference signs.

### First Embodiment

First, the overall configuration of a vehicle body structure according to a first embodiment of the disclosure will be described.

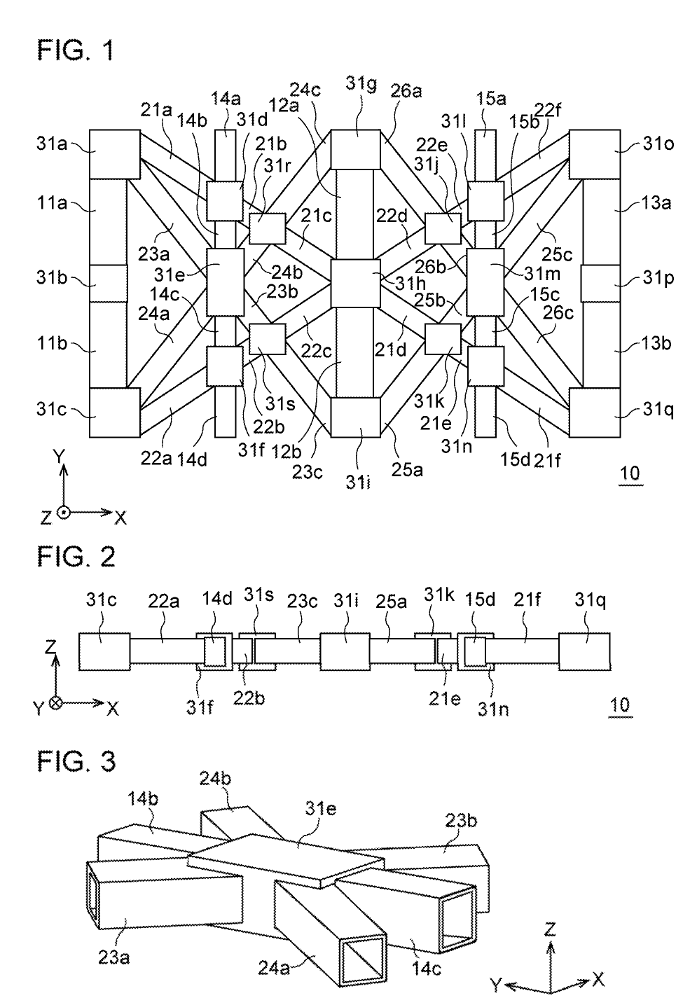

FIGS. 1 and 2 are schematic perspective views of a vehicle body structure 10. FIG. 1 is a plan view of the vehicle body structure 10 having a flat plate shape, and FIG. 2 is a side view of the vehicle body structure 10 illustrated in FIG. 1 when viewed from the lower side of FIG. 1.

The illustrated vehicle body structure 10 constitutes, for example, a floor structure of a vehicle body. The direction along the arrow X in each of the following drawings represents a front-rear direction of the vehicle body, and the direction of the arrow X indicates the rear of the vehicle body. The direction along the arrow Y in each of the drawings represents a left-right direction of the vehicle body, and the direction of the arrow Y indicates the right side of the vehicle body. The direction along the arrow Z in each of the drawings represents a height direction of the vehicle body, and the direction of the arrow Z indicates the upper side of the vehicle body.

The vehicle body structure 10 has a flat plate shape as a whole. Having a flat plate shape as a whole means having a shape in which, relative to the thickness of the vehicle body structure 10 in an axial direction of the three orthogonal axes (in the illustrated example, the Z direction), the lengths of the vehicle body structure 10 in vehicle body directions of the other axial directions (in the illustrated example, the X direction and the Y direction) are greater, and means having a shape that can be conceived as having two faces constituting the front and the back and a thickness that is the interval between the two faces.

The vehicle body structure 10 includes multiple fiber-reinforced resin composites 11 (11a and 11b), 12 (12a and 12b), 13 (13a and 13b), 14 (14a to 14d), 15 (15a to 15d), 21 (21a to 21f), 22 (22a to 22f), 23 (23a to 23c), 24 (24a to 24c), 25 (25a to 25c), and 26 (26a to 26c) having a tubular shape and coupled together. The fiber-reinforced resin composite is constituted mainly by a fiber-reinforced resin such as carbon fiber-reinforced plastic (hereinafter, referred to as CFRP) and may include a metal reinforcement and/or a metal fastening member. The vehicle body structure 10 may include a thin plate-shaped panel (not illustrated) that is disposed on one or both of the upper side and the lower side in the height direction of the vehicle body (the Z direction). The panel may be a panel of fiber-reinforced resin and may also be a panel of steel plate.

The composite using a fiber-reinforced resin, typified by CFRP, has high rigidity and exhibits high strength against the compressive stress or the tensile stress acting in the direction of orientation of fiber in one example. The fiber-reinforced resin-made composite is obtained by forming a fiber-reinforced resin that contains reinforced fiber mainly made of carbon fiber and/or aramid fiber and contains a matrix resin made of a thermoplastic resin or a thermosetting resin. However, the kind of the reinforced fiber is not limited to carbon fiber or aramid fiber. In addition, various fibers may be used as the reinforced fiber.

Examples of the thermoplastic resin include a polyethylene resin, a polypropylene resin, a polyvinyl chloride resin, an ABS resin (acrylonitrile-butadiene-styrene copolymer synthetic resin), a polystyrene resin, an AS resin (acrylonitrile-styrene copolymer synthetic resin), a polyamide resin, a polyacetal resin, a polycarbonate resin, a polyester resin, a PPS (polyphenylene sulfide) resin, a fluorocarbon resin, a polyetherimide resin, a polyether ketone resin, and a polyimide resin. The matrix resin may be one kind of or a mixture of two or more kinds of the above-described thermoplastic resins. The matrix resin may alternatively be a copolymer of the above-described thermoplastic resins. When the thermoplastic resin is such a mixture, a compatibilizer may further be used together. Furthermore, a flame retardant, examples of which include a bromine-based flame retardant, a silicon-based flame retardant, and red phosphorus, may be added to the thermoplastic resin.

Examples of the thermosetting resin include an epoxy resin, an unsaturated polyester resin, a vinyl ester resin, a phenol resin, a polyurethane resin, and a silicon resin. The matrix resin may be one kind of or a mixture of two or more kinds of the above-described thermosetting resins. When any one or more of the above-described thermosetting resins are used, an appropriate curing agent and/or an appropriate reaction accelerator may be added thereto.

The reinforced fiber may contain, in an appropriate ratio, fibers oriented in the axial direction of the tubular fiber-reinforced resin composite and fibers oriented in a direction intersecting the axial direction. The reinforced fiber may also contain short fibers cut to a few millimeters in length besides continuous fibers continuously extending in a predetermined direction.

The multiple tubular fiber-reinforced resin composites 11 to 15 and 21 to 26 include multiple first parts 11 to 15 extending in the left-right direction of the vehicle body and multiple second parts 21 to 26 extending in oblique directions that all slant to the front-rear direction and the left-right direction of the vehicle body. For example, the first part 11 includes two constituting portions 11a and 11b and is disposed extending along the left-right direction of the vehicle body. Similarly, the other first parts 12 to 15 include two or four constituting portions and are disposed extending along the left-right direction of the vehicle body.

In addition, the second part 21 includes six constituting portions 21a to 21f and is disposed extending along one of the oblique directions. Similarly, the other second parts 22 to 26 include three or six constituting portions and are disposed extending along the oblique directions. The second parts 21 and 22, which are the two thereamong, are disposed on the diagonal lines of the vehicle body structure 10. For example, the second part 21 is disposed on the diagonal line connecting the right front and the left rear of the vehicle body structure 10. The second part 22 is disposed on the diagonal line connecting the left front and the right rear of the vehicle body structure 10.

The first parts 11 to 15 and the second parts 21 to 26 include multiple intersections at which the first parts 11 to 15 and the second parts 21 to 26 are coupled together while intersecting with each other in the same plane. The state in which the first parts 11 to 15 and the second parts 21 to 26 intersect with each other in the same plane refers to the state in which the first parts 11 to 15 and the second parts 21 to 26 are layered on one plane, and portions at which the first parts 11 to 15 and the second parts 21 to 26 intersect with each other also exist in the plane. That is, the first parts 11 to 15 and the second parts 21 to 26 are disposed without mutually deviating in a thickness direction of the vehicle body structure 10 (the Z direction). However, a configuration in which a member associated with the vehicle body structure 10 exists at a position deviated from the plane is not intended to exclude.

At the multiple intersections, at each of which corresponding ones of the first parts 11 to 15 and the second parts 21 to 26 are coupled together while intersecting with each other, the vehicle body structure 10 according to the present embodiment includes respective coupling members 31 (31a to 31s). The coupling members 31 are each a rigid body having a block shape, formed with, for example, aluminum or resin, and having predetermined rigidity. The coupling members 31 are used to transmit a load among the mutually coupled first parts 11 to 15 and second parts 21 to 26.

The coupling members 31a and 31c of the vehicle body structure 10 are positioned at the right front and the left front of the vehicle body, respectively, while corresponding to spots at which the vehicle body structure 10 constituting a floor is coupled to a toe board or front pillars (not illustrated). The coupling members 31g and 31i of the vehicle body structure 10 are positioned at the right and the left of the center in the front-rear direction of the vehicle body, respectively, while corresponding to spots at which the vehicle body structure 10 constituting the floor is coupled to center pillars (not illustrated). The coupling members 31o and 31q of the vehicle body structure 10 are positioned at the right rear and the left rear of the vehicle body, respectively, while corresponding to spots at which the vehicle body structure 10 constituting the floor is coupled to a rear panel (not illustrated). Thus, the above-described coupling members 31a, 31c, 31g, 31i, 31o, and 31q receive the load during a frontal, rear or lateral collision of the vehicle body.

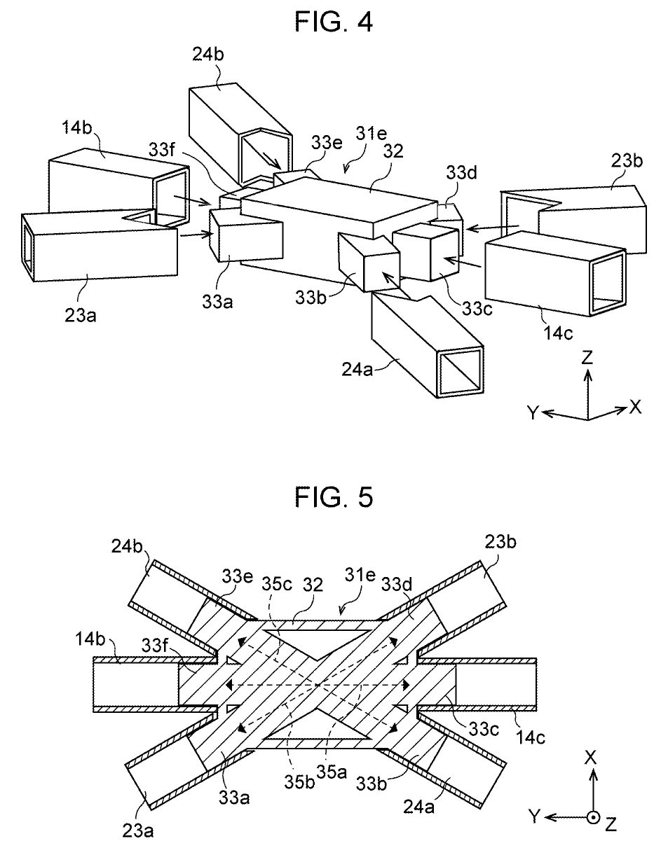

FIGS. 3 to 5 illustrate one example of, in the multiple intersections included in the vehicle body structure 10 illustrated in FIG. 1, the configuration of the intersection at which the first part 14 and the two second parts 23 and 24 intersect each other. FIG. 3 is a perspective view of the intersection. FIG. 4 is an exploded perspective view of the intersection. FIG. 5 is a sectional view of the intersection taken along the XY plane at an intermediate position in the Z direction. Note that FIGS. 3 to 5 illustrate only end portions, in the first part 14 and the second parts 23 and 24, coupled to the coupling member 31e.

The illustrated coupling member 31e includes a partition wall 32, protrusions 33 (33a to 33f), and ribs 35 (35a to 35c). The partition wall 32 is a wall portion constituting an outer shell of the coupling member 31e. The ribs 35 are wall-shaped portions provided, inside the coupling member 31e, along directions in which the first part 14 and the second parts 23 and 24 of the fiber-reinforced resin composites extend. The protrusions 33 extend from the respective ribs 35a to 35c and protrude outward from the coupling member 31e. Constituting portions 14b,14c, 23a, 23b, 24a, and 24b of the first part 14 and the second parts 23 and 24 are fitted onto the respective protrusions 33a to 33f and bonded thereto with an adhesive.

The constituting portions 14b and 14c of the first part 14 are coupled to the protrusions 33f and 33c extending from both ends of the rib 35a and protruding outward from the coupling member 31e. The rib 35a extends along the first part 14 inside the coupling member 31e and may serve as a load transmission path between the constituting portions 14b and 14c of the first part 14.

The constituting portions 23a and 23b of the second part 23 are coupled to the protrusions 33a and 33d extending from both ends of the rib 35b and protruding outward from the coupling member 31e. The rib 35b extends along the second part 23 inside the coupling member 31e and may serve as a load transmission path between the constituting portions 23a and 23b of the second part 23.

The constituting portions 24a and 24b of the second part 24 are coupled to the protrusions 33b and 33e extending from both ends of the rib 35c and protruding outward from the coupling member 31e. The rib 35c extends along the second part 24 inside the coupling member 31e and may serve as a load transmission path between the constituting portions 24a and 24b of the second part 24.

The ribs 35a to 35c are formed into one body and used to transmit the load mutually between the first part 14 and the second parts 23 and 24 and to distribute the load in the multi-axial directions.

The coupling member 31e can be produced by, for example, die molding, forming using a 3D printer, or cutting. However, the producing method of the coupling member 31e is not particularly limited.

The intersections other than the intersection of the first part 14 and the second parts 23 and 24 are similarly provided with coupling members 31a to 31s excluding 31e, each including protrusions to which constituting portions of the first and second parts are coupled, and the constituting portions of the first and second parts are coupled together, with the corresponding coupling member therebetween.

As described above, the flat plate-shaped vehicle body structure 10 according to the present embodiment includes the multiple tubular fiber-reinforced resin composites that are coupled together. The multiple tubular fiber-reinforced resin composites include the multiple first parts 11 to 15 extending in the left-right direction of the vehicle body and the multiple second parts 21 to 26 extending in the oblique directions that all slant to the front-rear direction and the left-right direction of the vehicle body. The second parts 21 and 22, which are some of the multiple second parts 21 to 26, are disposed on the diagonal lines of the vehicle body structure 10. The multiple tubular fiber-reinforced resin composites include the multiple intersections at which the first parts 11 to 15 and the second parts 21 to 26 are coupled together while intersecting with each other in the same plane. Thus, the input load can be distributed in the multi-axial directions by increasing the number of load transmission paths in the same plane without stacking the mutually intersecting first and second parts in the height direction of the vehicle body and without increasing the thickness of the flat plate-shaped vehicle body structure.

Since the first parts 11 to 15 and the second parts 21 to 26 are coupled together while intersecting with each other in the same plane, good torsional characteristics of the vehicle body structure 10 can be achieved. In one example, the vehicle body structure 10 according to the present embodiment is applied to the floor structure of the vehicle body and joined to other multiple structural members such as a toe board, front pillars, center pillars, and rear pillars and allows facilitation in the design of load transmission paths provided for distributing the load input during any collision such as frontal, rear, or lateral collision of the vehicle body or rollover of the vehicle and thus for reducing deformation of the vehicle body. Accordingly, a design enabling impact resistance can be achieved.

The flat plate-shaped vehicle body structure 10 according to the present embodiment further includes, at each of the multiple intersections at each of which corresponding ones of the first parts 11 to 15 and the second parts 21 to 26 are coupled together while intersecting with each other in the same plane, the coupling member 31 configured to couple the corresponding ones of the first parts 11 to 15 and the second parts 21 to 26. Thus, while reduction in the strength of the intersections is suppressed, the first parts 11 to 15 and the second parts 21 to 26 are allowed to be coupled together while intersecting with each other in the same plane.

In the flat plate-shaped vehicle body structure 10 according to the present embodiment, some of the coupling members 31 are provided so as to correspond to the joining positions with other multiple structural members such as a toe board, front pillars, center pillars, and rear pillars. Thus, the load input during any collision such as frontal, rear, or lateral collision of the vehicle body or rollover of the vehicle can be quickly transmitted to the fiber-reinforced resin composites of the vehicle body structure 10 and can thus be distributed efficiently.

In the flat plate-shaped vehicle body structure 10 according to the present embodiment, each of the coupling members 31 transmits the load between corresponding ones, of the first parts 11 to 15 and the second parts 21 to 26, that are coupled to the coupling member 31. Thus, the load input to the vehicle body structure 10 can be easily distributed in the multi-axial directions through the coupling members 31.

In the flat plate-shaped vehicle body structure 10 according to the present embodiment, each of the coupling members 31 includes the multiple protrusions 33 extending along the load transmission directions and protruding outward, and the constituting portions of corresponding ones of the first parts 11 to 15 and the second parts 21 to 26 and the protrusions 33 are fitted and coupled to each other. Thus, the coupling members 31 and the first parts 11 to 15 and the second parts 21 to 26 of the fiber-reinforced resin composites can be easily positioned and firmly coupled together. In the flat plate-shaped vehicle body structure 10 according to the present embodiment, the multiple protrusions 33 extend continuously from the ribs 35 that are the load transmission paths extending along the load transmission directions inside the coupling member 31. Thus, the load is efficiently transmitted in the directions where the first parts 11 to 15 and the second parts 21 to 26 extend. Since the multiple ribs 35a to 35c are formed into one body, the input load can be efficiently distributed in the multi-axial directions.

### Modification

Although, in the above-described embodiment, the multiple intersections, at which the first parts and the second parts of the fiber-reinforced resin composites are coupled together while intersecting with each other in the same plane, have a configuration in which the fiber-reinforced resin composites are fitted onto and coupled to the respective protrusions provided in each of the coupling members, the configuration of the intersection is not limited to the above-described example.

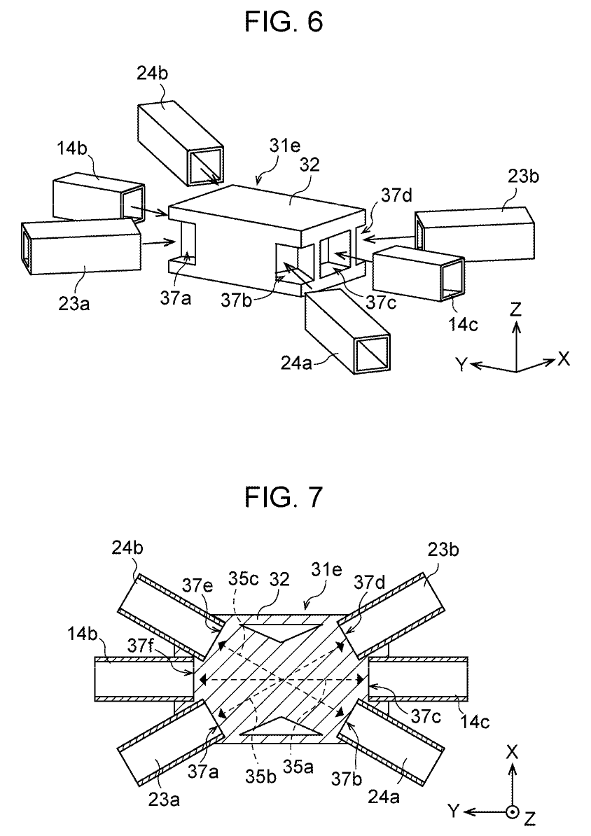

FIGS. 6 and 7 illustrate a modification of the configuration of the intersection and correspond to FIGS. 4 and 5. FIG. 6 is an exploded perspective view of an intersection of the modification. FIG. 7 is a sectional view of the intersection of the modification taken along the XY plane at an intermediate position in the Z direction.

An illustrated coupling member 31e includes a partition wall 32, insertion openings 37 (37a to 37f) each provided with a bottom, and ribs 35(35a to 35c). The insertion openings 37 are open at end portions of the respective ribs 35a to 35c and provided along directions where the ribs 35a to 35c extend. Constituting portions 14b, 14c,23a, 23b, 24a, and 24b of a first part 14 and second parts 23 and 24 are fitted into the respective insertion openings 37a to 37f and bonded thereto with an adhesive.

The constituting portions 14b and 14c of the first part 14 are respectively coupled to the insertion openings 37f and 37c opened at both ends of the rib 35a. The rib 35a extends along the first part 14 inside the coupling member 31e and may serve as a load transmission path between the constituting portions 14b and 14c of the first part 14.

The constituting portions 23a and 23b of the second part 23 are respectively coupled to the insertion openings 37a and 37d opened at both ends of the rib 35b. The rib 35b extends along the second part 23 inside the coupling member 31e and may serve as a load transmission path between the constituting portions 23a and 23b of the second part 23.

The constituting portions 24a and 24b of the second part 24 are respectively coupled to the insertion openings 37b and 37e opened at both ends of the rib 35c. The rib 35c extends along the second part 24 inside the coupling member 31e and may serve as a load transmission path between the constituting portions 24a and 24b of the second part 24.

The ribs 35a to 35c are formed into one body and used to transmit the load mutually between the first part 14 and the second parts 23 and 24 and to distribute the load in the multi-axial directions.

Even with the configuration of the intersection according to the above-described modification, similar effects to those of the vehicle body structure 10 according to the above-described embodiment can be obtained.

### Second Embodiment

Subsequently, a vehicle body structure according to a second embodiment of the disclosure will be described.

The vehicle body structure according to the above-described first embodiment includes the tubular fiber-reinforced resin composites and the intersections, at each of which corresponding fiber-reinforced resin composites are fitted and joined to the protrusions or the insertion openings of the coupling member 31. The vehicle body structure according to the second embodiment includes fiber-reinforced resin composites having a hat shape and includes, at an intersecting spot thereof, an intersection at which multiple fiber-reinforced resin composites are layered on top of each other and joined or fastened together.

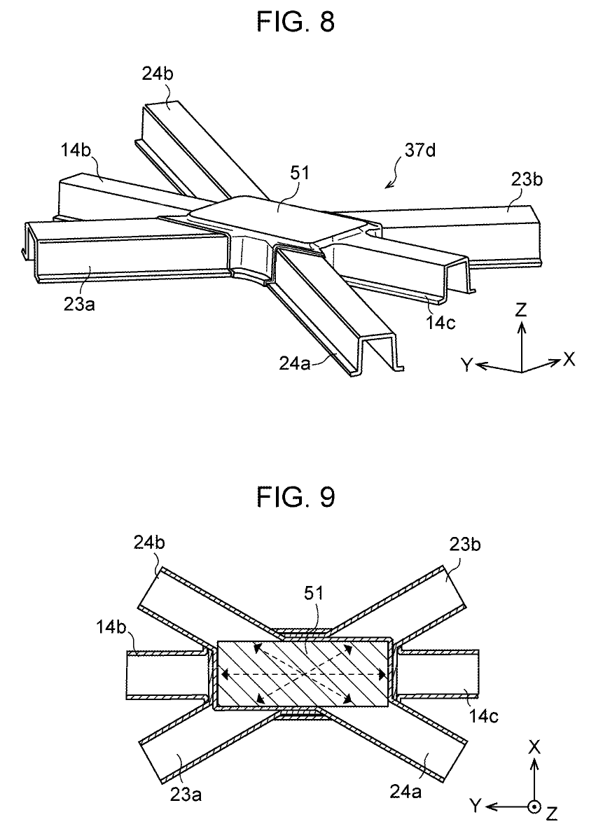

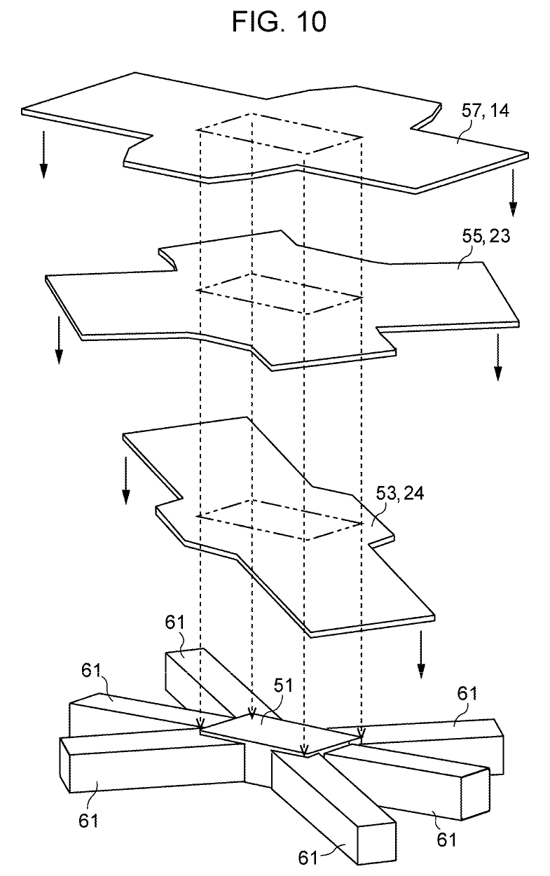

FIGS. 8 and 9 illustrate the configuration of the intersection of the vehicle body structure according to the present embodiment and correspond to FIGS. 3 and 5. FIG. 8 is a perspective view of the intersection of the vehicle body structure according to the present embodiment. FIG. 9 is a sectional view of the intersection of the vehicle body structure according to the present embodiment taken along the XY plane at an intermediate position in the Z direction.

The vehicle body structure according to the present embodiment includes first parts 14 (14a and 14b) and second parts 23 (23a and 23b) and 24 (24a and 24b) of the hat-shaped fiber-reinforced resin composites that are layered on top of each other and joined together at the intersection. The first parts 14 (14a and 14b) and the second parts 23 (23a and 23b) and 24 (24a and 24b) are layered on top of each other so as to cover a coupling member 51. In the illustrated example, on the coupling member 51, one second part 24, another second part 23, and further the first part 14 are layered on top of each other in this order.

FIG. 10 illustrates an example of a manufacturing method of the vehicle body structure according to the present embodiment.

On the coupling member 51 and a mold 61, a softened fiber-reinforced resin sheet 53 to be formed into one second part 24 is disposed so as to cover the coupling member 51 and the mold 61. Subsequently, a softened fiber-reinforced resin sheet 55 to be formed into another second part 23 is disposed so as to cover the coupling member 51 and the mold 61 from above the fiber-reinforced resin sheet 53. Subsequently, a softened fiber-reinforced resin sheet 57 to be formed into the first part 14 is disposed so as to cover the coupling member 51 and the mold 61 from above the fiber-reinforced resin sheets 53 and 55.

The fiber-reinforced resin sheets 53, 55, and 57 are then formed according to the shapes of surfaces of the coupling member 51 and forming surfaces of the mold 61, and are solidified and subsequently removed from the mold 61. Thus, there can be obtained a vehicle body structure including an intersection at which the fiber-reinforced resin sheets 53, 55, and 57 are layered on top of each other and joined together on the coupling member 51, and including the first part 14 and the second parts 23 and 24 of the hat-shaped fiber-reinforced resin composites that extend from the intersection.

A fiber-reinforced resin layer or a resin layer for covering the layered first part 14 and second parts 23 and 24 may be provided in the vicinity of the intersection. The outermost fiber-reinforced resin sheet 57 may be used to join or fasten the fiber-reinforced resin sheets 53 and 55 in the inner layers to the coupling member 51. In addition, one or multiple fastening members such as a bolt may be used to fix the fiber-reinforced resin sheets 53, 55, and 57 to the coupling member 51. Thus, the joining strength of the fiber-reinforced resin composites at the intersection can be increased.

As described above, the flat plate-shaped vehicle body structure according to the present embodiment includes the multiple hat-shaped fiber-reinforced resin composites that are coupled together and the multiple intersections at which the first parts and the second parts of the multiple fiber-reinforced resin composites are coupled together while intersecting with each other in the same plane. Thus, effects similar to those of the vehicle body structure according to the first embodiment can be obtained.

In addition, in the flat plate-shaped vehicle body structure according to the present embodiment, the first and second parts of the multiple fiber-reinforced resin composites are layered on top of each other so as to cover the coupling member and joined or fastened together at the intersection. Thus, the coupling member and the first and second parts of the fiber-reinforced resin composites can be firmly coupled together.

Note that the order in which the fiber-reinforced resin sheets to be formed into the first and second parts are layered is not limited to the above-described example and may be any order.

Although the embodiments of the technique of the disclosure have so far been described in detail with reference to the accompanying drawings, the technique of the disclosure is not limited to the examples. Various modifications or alterations will be apparent to those skilled in the art to which the present disclosure belongs, within the range of the technical idea described in claims, and it is to be understood that the technical scope of the disclosure also encompasses the modifications and alterations.

For example, in the above-described embodiments, the examples in which the vehicle body structures are used for the vehicle body floor structure have been described, but the technique of the disclosure is not limited to the above-described examples. For example, the vehicle body structure may be used for the structure of a roof of the vehicle body and may also be used for the structure of a door panel or a body.

In addition, the planar pattern formed by the fiber-reinforced resin composites is not also limited to the examples of the above-described embodiments and may be freely designed according to desired load transmission paths (load paths).

As described above, according to the technique of the disclosure, the thickness of the vehicle body structure having a flat plate shape can be reduced, and the input load can be distributed in the multi-axial directions.

1. A vehicle body structure having a flat plate shape, the vehicle body structure comprising:
a plurality of fiber-reinforced resin composites each having a tubular shape or a hat shape and coupled together, wherein
the fiber-reinforced resin composites comprise:
a plurality of first parts extending in a front-rear direction or a left-right direction of a vehicle body and a plurality of second parts extending in oblique directions that all slant to the front-rear direction and the left-right direction of the vehicle body,
some of the second parts being disposed on diagonal lines of the vehicle body structure; and
intersections at which the first parts and the second parts are coupled together while intersecting with each other in a same plane.

2. The vehicle body structure according to claim 1, further comprising:
a coupling member configured to couple a corresponding first part of the first parts and a corresponding second part of the second parts at a corresponding intersection of the intersections.

3. The vehicle body structure according to claim 2, wherein
the coupling member transmits a load between the corresponding first part and the corresponding second part coupled to the coupling member.

4. The vehicle body structure according to claim 3, wherein
the coupling member comprises a plurality of protrusions extending along load transmission directions and protruding outward, and the corresponding first part and the corresponding second part and the protrusions are fitted and coupled to each other.

5. The vehicle body structure according to claim 4, wherein
the protrusions extend continuously from ribs that are load transmission paths extending along the load transmission directions inside the coupling member.
